(19) United States
(12) Patent Application Publication
(10) Pub. No.: US 2017/0103642 A1
(43) Pub. Date: Apr. 13, 2017

(54) Emergency Communication Platform

(71) Applicant: Charles L. Stephenson, (US)

(72) Inventor: Charles Stephenson, McDonough, GA (US)

(21) Appl. No.: 14/881,409

(22) Filed: Oct. 13, 2015

(51) Int. Cl. G08B 27/00; G06F 19/00

(52) U.S. Cl. CPC G08B 27/001; G06F 19/3418

(57) ABSTRACT

An emergency communication platform may be provided. The emergency communication platform may provide systems and methods for enabling communication and effective actions taken by responders. The platform may first receive emergency information from a user. In some embodiments, the platform may receive the emergency information via short-range communication and relay the information to a server. The platform may then process the emergency information and aggregate emergency information from other users. Subsequently, they platform may analyze the data and provide the analyzed information to a responder in a useable form.

### FIELD OF DISCLOSURE

The present disclosure generally relates to providing a network communication alternative.

### BACKGROUND

With general reliance on mobile phone access, a network outage can be devastating. Further, network outings are often caused by disasters. Presently, there are limited communication methods available in the event of a network outing.

Additionally, in the case of a disaster, as a disaster response individual, assessing the situation (e.g., how many people are in each location, how many people are injured, how many people require a blood transfusion, what type of blood for the transfusion, etc.) can be difficult, as the information that is received may not be preformatted in order to efficiently sort and analyze, resulting in sub-optimal response.

### BRIEF OVERVIEW

An emergency communication platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The emergency communication platform may provide systems and methods for enabling communication and effective actions taken by responders. The platform may first receive emergency information from a user. In some embodiments, the platform may receive the emergency information via short-range communication and relay the information to a server. The platform may then process the emergency information and aggregate emergency information from other users. Subsequently, they platform may analyze the data and provide the analyzed information to a responder in a useable form.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing an emergency communication platform;

FIG. 3 illustrates a user interface for receiving emergency data from a user;

FIG. 4 illustrates a user interface for providing user information;

FIG. 5 illustrates an interface for enabling the user to connect to a relay device;

FIG. 6 illustrates a map for providing information to a responder;

FIG. 7 illustrates an interface for receiving incoming messages in a text box;

FIG. 8 illustrates an interface for posting to social media; and

FIG. 9 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of emergency response, embodiments of the present disclosure are not limited to use only in this context. For example, the context may be applied to Military Troop rescue and off grid extraction, First Respondents (Military, FEMA, American Red Cross, Police Departments, Firefighters), Coast Guard, NASA, Department of Homeland Security and Anyone seeking emergency assistance who's mobile device lacks a viable cellular signal.

I. Platform Overview

Consistent with embodiments of the present disclosure, an emergency communication platform may be provided. This overview is provided to introduce a selection of concepts in a simplified form that are further described below. This overview is not intended to identify key features or essential features of the claimed subject matter. Nor is this overview intended to be used to limit the claimed subject matter's scope. The emergency communication platform may be used by individuals or groups to enable interoperability between a plurality of disparate communication systems.

The platform may enable communication in the event of an emergency. For example, the platform may provide an alternative method for communicating with a cell network during an outage. In the event that cell networks are down, the platform may receive alternative communication signals (e.g., short-wave communication including Bluetooth communication, Wi-Fi, etc.). The platform may receive the alternative communication signals via relay hubs, such as, for example, drones or flotillas equipped with a signal receiving system (e.g., a Bluetooth server) and a signal transmission device (e.g., satellite communication (“Satcom”)). The relay hubs may, in turn, relay the information received from the alternative communication signals to a server.

In some embodiments, the platform may enable a responder to acquire a set of preformatted data. For example, the platform may request specific information from a user pertaining to the emergency including, but not limited to, a number of individuals in distress, any injuries, types of injuries, location (which may, in some embodiments, be detected by a location detection device, e.g., GPS), contact information for a user, medical/other supplies required.

Once the platform receives the preformatted data, the platform may enter the preformatted data into a database. Then, the platform may organize and sort the data to provide usable information to the responder. For example, the platform may provide the responder with the type and amount of supplies and support necessary for a given location. Further, the platform may enable the responder to prioritize by ranking the level of each injury. Additionally, the platform may provide the responder with available resources for enabling efficient allocation of such resources.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

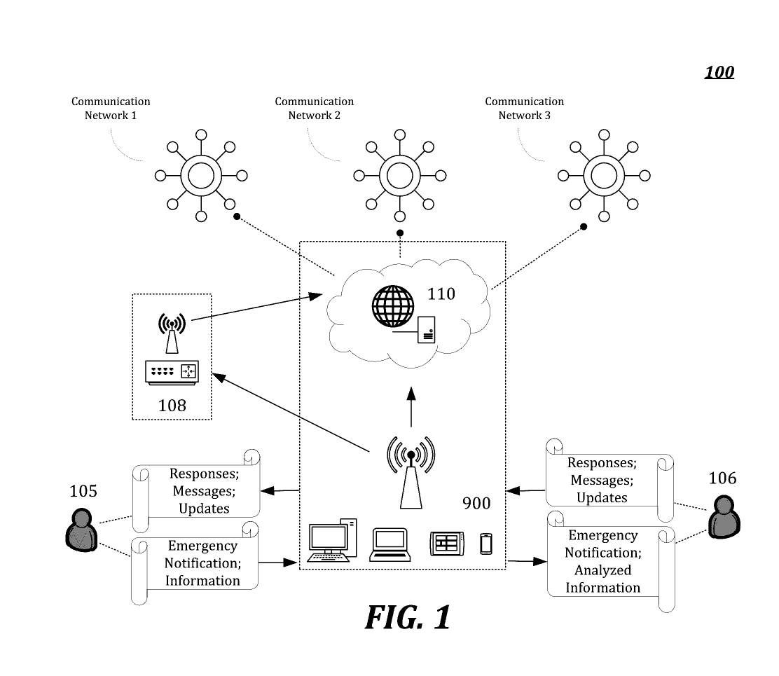

FIG. 1 illustrates one possible operating environment through which a platform consistent with embodiments of the present disclosure may be provided. By way of non-limiting example, an emergency communication platform 100 may be hosted on a centralized server 110, such as, for example, a cloud computing service. A user 105 and a responder 106 may access platform 100 through a software application. The software application may be embodied as, for example, but not be limited to, a website, a web application, a desktop application, and a mobile application compatible with a computing device 900. One possible embodiment of the software application may be known as Rescue Pigeon™ invented and developed by Charles Stephenson,

The software application may relay information to the server via a relay hub 108. For example, the relay hub 108 may comprise a device configured to receive a signal, such as, for example, a Bluetooth or Wi-Fi signal, and relay the signal to the server via, for example, a satellite communication signal or wired network. The relay hub 108 may be embodied as, for example, a drone or other air vehicle, flotilla, or truck.

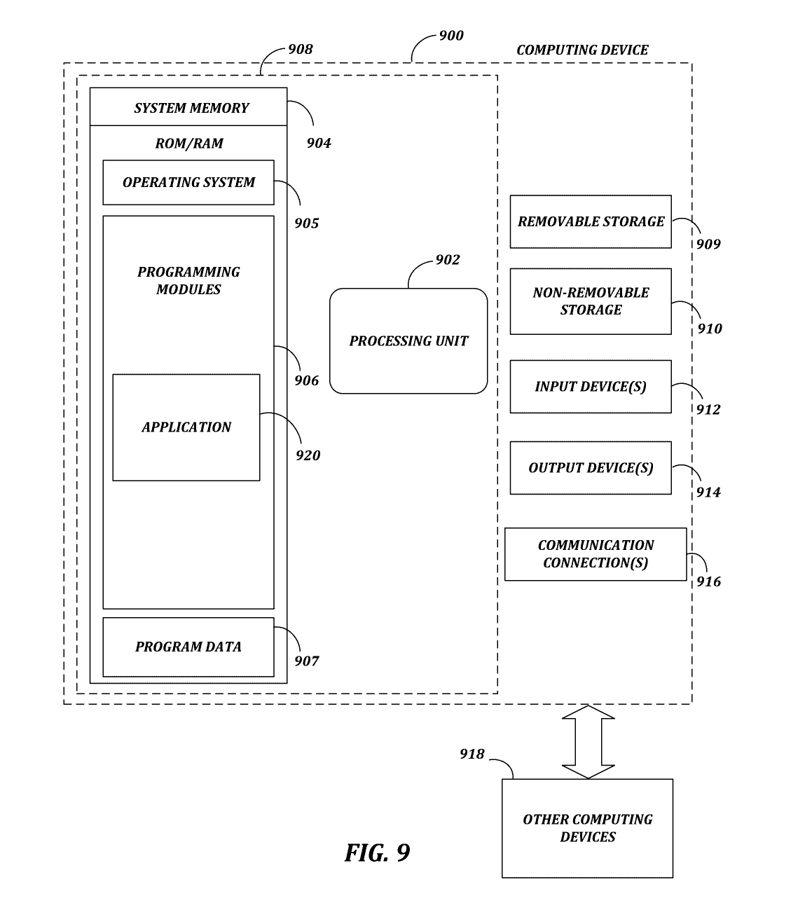

As will be detailed with reference to FIG. 9 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

III. Platform Operation

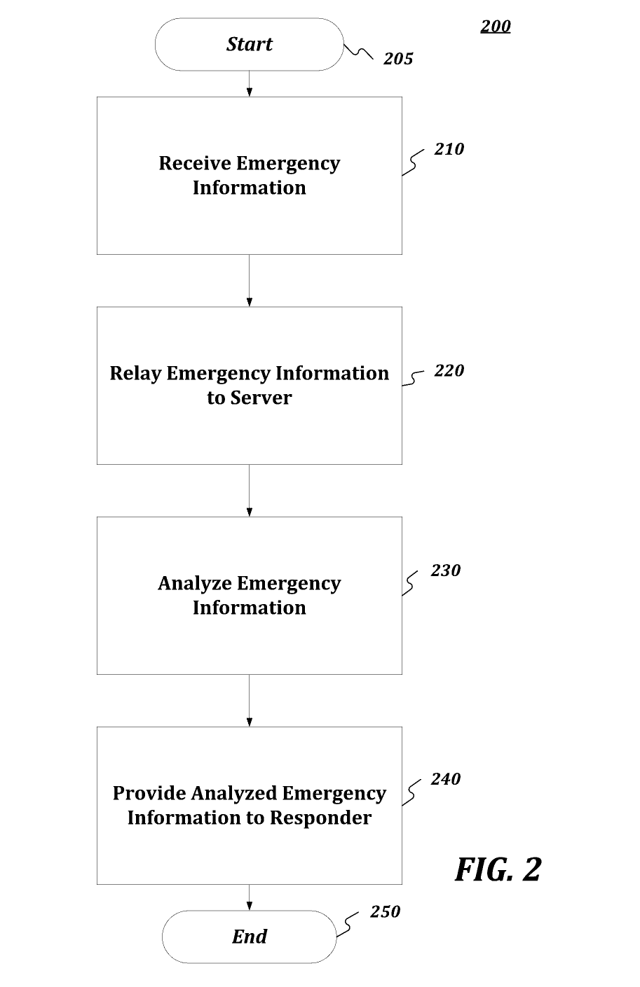

FIG. 2 is a flow chart setting forth the general stages involved in a method 200 consistent with an embodiment of the disclosure for providing the emergency communication platform 100. Method 200 may be implemented using a computing device 900 as described in more detail below with respect to FIG. 9.

Although method 200 has been described to be performed by platform 100, it should be understood that computing device 900 may be used to perform the various stages of method 200. Furthermore, in some embodiments, different operations may be performed by different networked elements in operative communication with computing device 900. For example, server 110 may be employed in the performance of some or all of the stages in method 200. Moreover, server 110 may be configured much like computing device 900. Similarly, relay hub 108 may be employed in the performance of some or all of the stages in method 200. Relay hub 108 may also be configured much like computing device 900.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

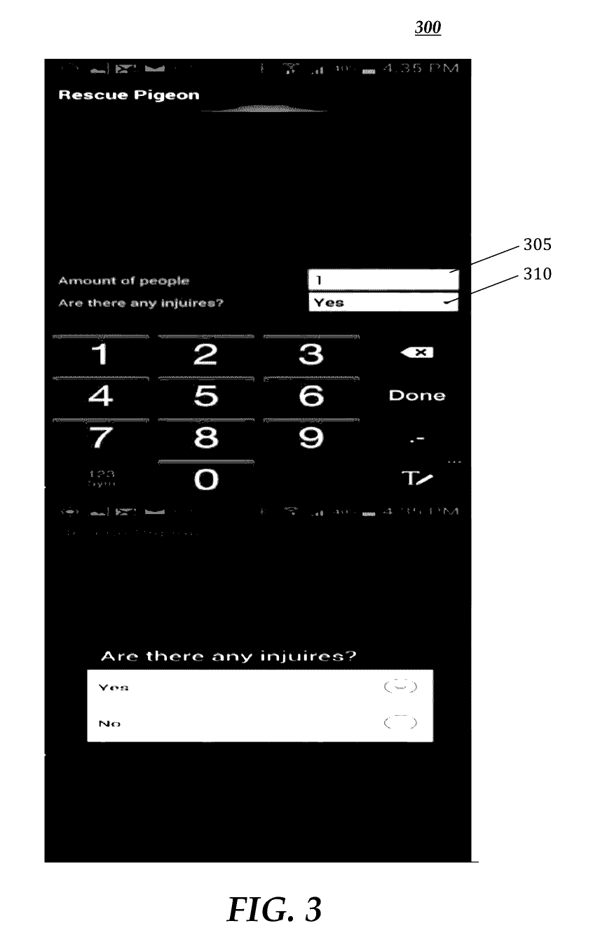

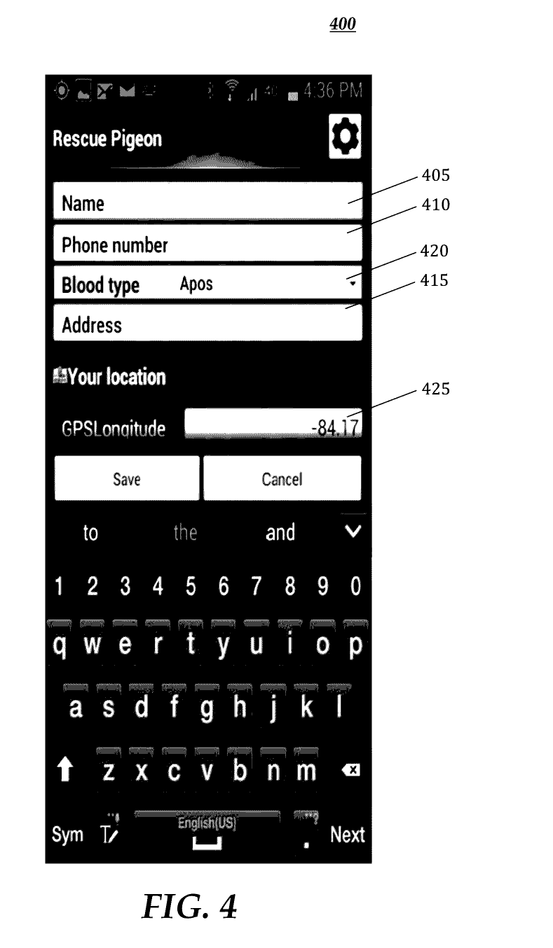

Method 200 may begin at starting block 205 and proceed to stage 210 where platform 100 may receive emergency information. For example, platform 100 may provide the user with a plurality of inputs. FIG. 3 illustrates a user interface 300 for receiving emergency data from a user. For example, entry box 305 illustrates a place for a user to enter the number of people around and entry box 310 for indicating whether or not there are any injuries. In further embodiments, the platform may enable the user to indicate further information, including, but not limited to, a type of injury, a severity of injury, and further information to enable a responders to prepare accordingly. The platform may acquire further user information. FIG. 4 illustrates a user interface 400 for providing user information, including the user's name 405, phone number 410, address 415, blood type 420, and location 425. In some embodiments, the location may be automatically entered by a GPS or other location-determining device associated with the user's device.

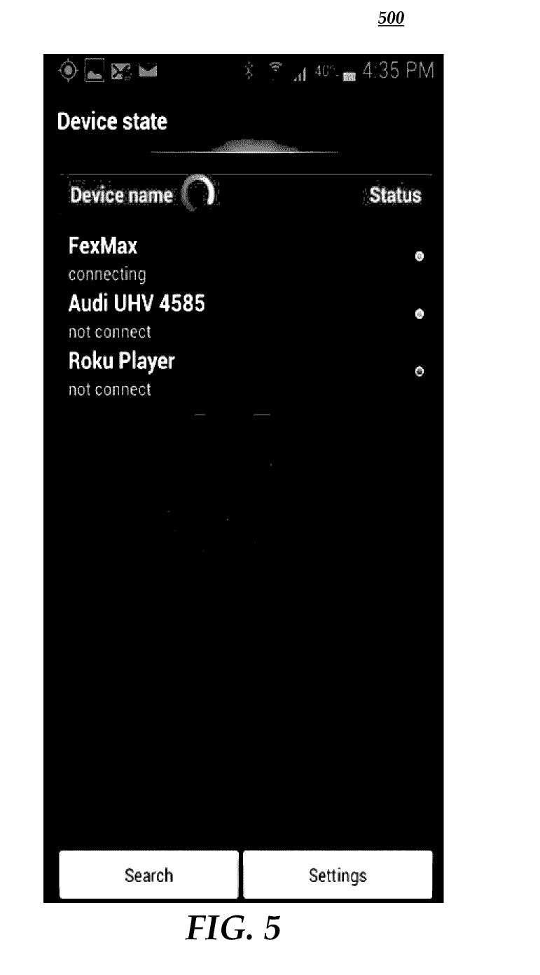

The platform may enable the user to connect to a relay device via a transmission signal, such as, for example, but not limited to, Bluetooth and Wi-Fi. FIG. 5 illustrates an interface 500 for enabling the user to connect to a relay device.

From stage 210, where platform 100 receives the emergency information, method 200 may advance to stage 220 where platform 100 may relay the emergency data to a server. The platform may do so by relaying the information through a relay device configured to provide a hotspot configured to receive a short-range signal, such as, for example, Bluetooth and Wi-Fi. The relay device may convert the received signal to a signal configured to be transmitted a long range, such as, for example, a wired connection or a satellite communication signal. The converted signal may then be transmitted to the server.

Once platform 100 relays the emergency information to a server in stage 220, method 200 may continue to stage 230 where platform 100 may analyze the emergency information. For example, the platform may aggregate and sort information. In further embodiments, the platform may determine necessary provisions for a response. For example, if there are a certain type of injury, the platform may determine a type of blood required for transfusion. In further embodiments, the platform may determine the amount and type of required food, blankets, transportation, medical supplies, shelters, etc.

After platform 100 analyzes the emergency information in stage 230, method 200 may proceed to stage 240 where platform 100 may provide the analyzed emergency information to a responder, such as, for example, but not limited to, FEMA, the police, fire department, EMS, Red Cross, National Guard, the department of human services (DHS) etc. The responder may receive, for example, but not limited to:

a number of individuals in distress;

a location or locations of the individuals in distress;

a type of distress;

a number of injuries;

types of injuries;

severity of injuries; and

necessary supplies for response.

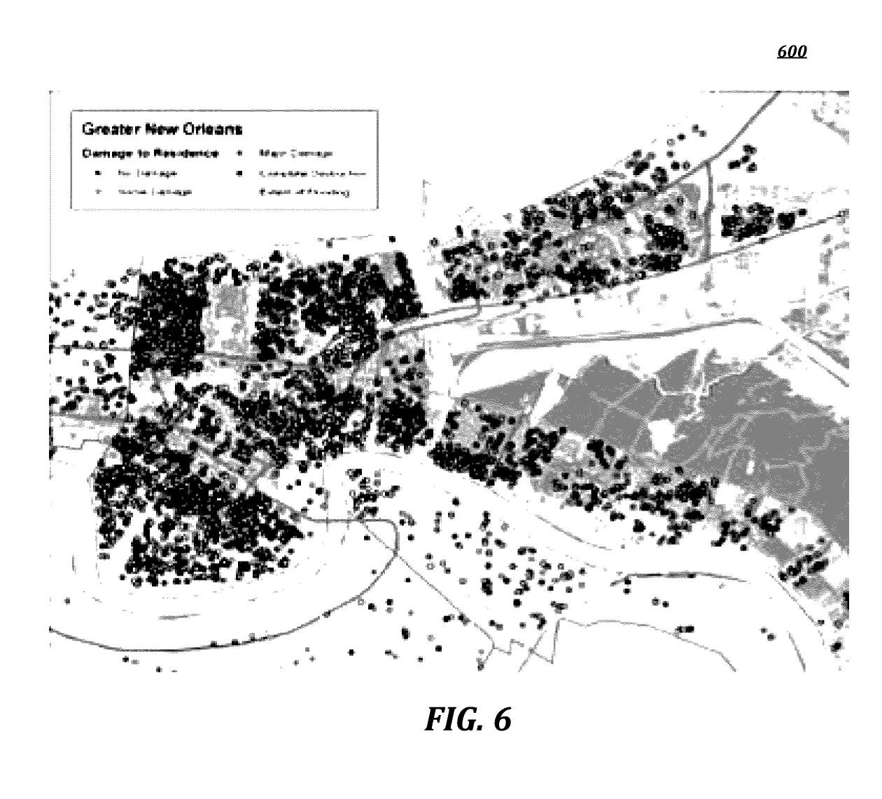

The platform may provide the analyzed information in a plurality of charts and graphs. In some embodiments, the information may be provided in a map 600, as illustrated in FIG. 6. In further embodiments, the platform may provide the responder with inventory of supplies, provisions, and resources to enable the responder to properly allocate resources. Once platform 100 provides the analyzed emergency information to the responder in stage 240, method 200 may then end at stage 250.

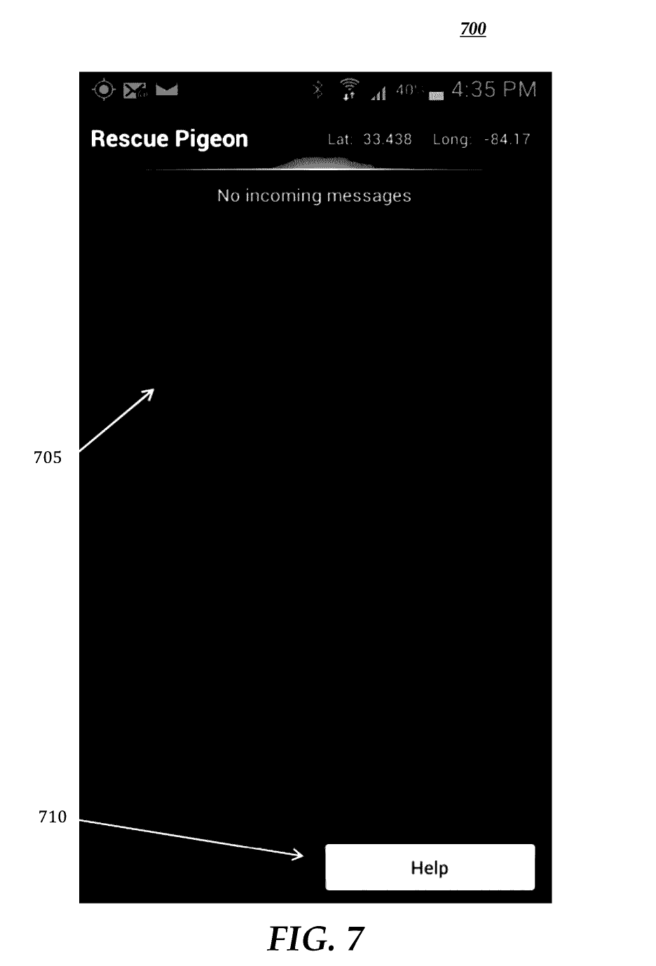

In further embodiments, the platform may enable the user to receive messages. For example, the platform 100 may enable the responder to push notifications to the user (e.g., the responder may inform the user as to when help is expected to arrive, or the status of the response). FIG. 7 illustrates an interface 700 for receiving incoming messages in a text box 705. Button 710 may enable the user to create an alert for sending emergency information.

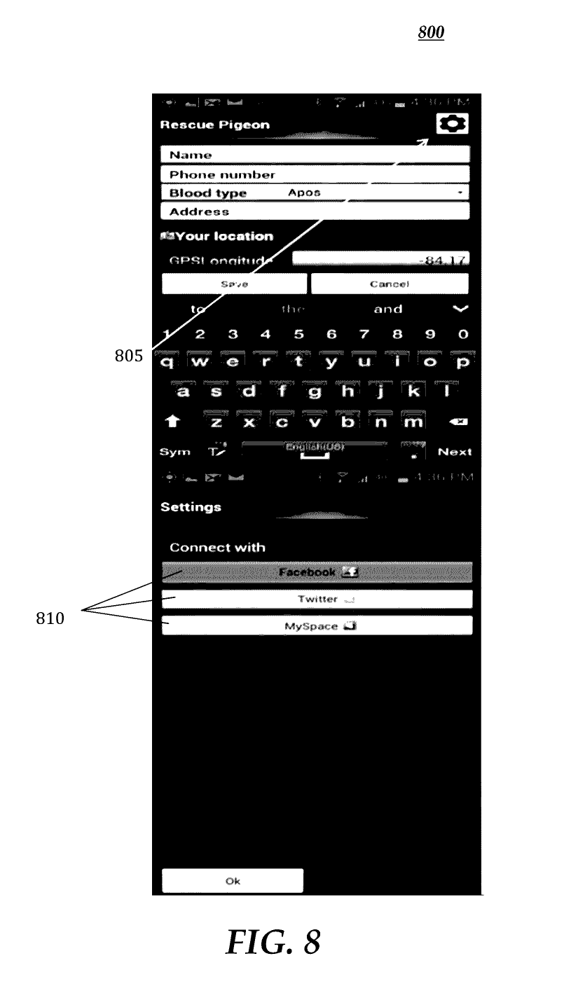

In yet further embodiments, the platform may enable the user to post to social media. FIG. 8 illustrates an interface 800 for posting to social media by providing a button 805 for requesting a post and buttons 810 for selecting which social media platform for posting. In this way, a user may inform family, friends, loved ones, etc. as to his or her status.

IV. Platform Architecture

The emergency communication platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 200 has been described to be performed by a computing device 900, it should be understood that, in some embodiments, different operations may be performed by different networked elements in operative communication with computing device 900.

Embodiments of the present disclosure may comprise a system having a memory storage and a processing unit. The processing unit coupled to the memory storage, wherein the processing unit is configured to perform the stages of method 200.

FIG. 9 is a block diagram of a system including computing device 900. Consistent with an embodiment of the disclosure, the aforementioned memory storage and processing unit may be implemented in a computing device, such as computing device 900 of FIG. 9. Any suitable combination of hardware, software, or firmware may be used to implement the memory storage and processing unit. For example, the memory storage and processing unit may be implemented with computing device 900 or any of other computing devices 918, in combination with computing device 900. The aforementioned system, device, and processors are examples and other systems, devices, and processors may comprise the aforementioned memory storage and processing unit, consistent with embodiments of the disclosure.

With reference to FIG. 9, a system consistent with an embodiment of the disclosure may include a computing device, such as computing device 900. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include emergency data collection application 920. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and nonvolatile, removable and non-removable media implemented in any method or technology for storage of information, such as computer readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., emergency data collection application 920) may perform processes including, for example, one or more of method 200's stages as described above. The aforementioned process is an example, and processing unit 902 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method comprising:
receiving a short-range signal comprising emergency data;
relaying the short-range signal to a server;
analyzing the emergency data; and
providing the analyzed emergency data to a responder.

2. The method of claim 1, wherein receiving the emergency comprises receiving at least one of the following: a location, a number of people in distress, a type of distress, a number of injured people, a type of injury, and a required blood type for transfusion.

3. The method of claim 1, wherein receiving the short range signal comprises receiving at least one of the following: a Bluetooth signal and a Wi-Fi signal.

4. The method of claim 1, wherein receiving the short range signal comprises receiving the signal on at least one of the following: a drone, and a flotilla.

5. The method of claim 1, wherein relaying the signal comprises:
converting the signal to at least one of the following: a satellite communication and a wired communication; and
transmitting the converted signal.

6. The method of claim 1, further comprising posting the emergency data to social media.

7. The method of claim 1, wherein providing the emergency data to the responder comprises providing a map.

8. The method of claim 7, wherein the heat map corresponds to at least one of the following: a number of injuries, a number of individuals, and a level of emergency.

9. The method of claim 1, wherein providing the emergency data to the responder comprises providing a sortable list of injuries.

10. The method of claim 1, further comprising:
receiving a message from the responder;
transmitting the message to a user's device via a short-range signal; and
providing the message to the user.

11. The method of claim 1, further comprising enabling the user to post information to a social media platform.

12. The method of claim 1, further comprising receiving resources available to the responder.

13. The method of claim 12, further comprising enabling the responder to allocate the available resources to based on the analyzed emergency data.

14. The method of claim 12, wherein receiving recourses available to the responder comprises receiving at least one of the following: available man hours, available transportation resources, available food, available blood, and available medical supplies.

15. A computer-readable medium comprising a set of instructions, which, when executed, perform a method comprising:
receiving a plurality of emergency data reports;
aggregating the plurality of emergency data reports;
analyzing the aggregated plurality of emergency data reports; and
providing an analysis of the aggregated plurality of emergency data reports to a responder.

16. The method of claim 1, further comprising:
receiving a message from the responder;
transmitting the message to a user's device; and
providing the message to the user.

17. The method of claim 1, further comprising enabling the user to post information to a social media platform.

18. A system comprising:
a memory storage;
a relay device comprising a wireless receiver, a signal converting device and a transmission device operative to:
receive a short-range emergency transmission,
convert the short-range emergency transmission to a long-range transmission, and
transmit the long-range transmission; and
a processing unit coupled to the memory storage, wherein the processing unit is operative to:
receive the long-range emergency transmission;
analyze the long-range emergency transmission; and
provide the analyzed long-range emergency transmission to a responder.

19. The system of claim 18, wherein the processing unit is further operative to:
receive a message from the responder; and
transmit the message to a user's device via the transmission device.

20. The system of claim 18, wherein the processing unit is further operative to enabling the user to post information to a social media platform.
